(19) United States
(12) Patent Application Publication
(10) Pub. No.: US 2016/0223332 A1
(43) Pub. Date: Aug. 4, 2016

(54) LOCATION QUALITY BY PRE-FETCHING AP LOCATIONS

(71) Applicant: Google Inc., Mountain View, CA (US)

(72) Inventor: Stanley Andrews CHESNUTT, Berkeley, CA (US)

(73) Assignee: Google Inc., Mountain View, CA (US)

(21) Appl. No.: 13/689,623

(22) Filed: Nov. 29, 2012

(51) Int. Cl. G01C 21/00

(52) U.S. Cl. CPC G01C 21/00

(57) ABSTRACT

The subject matter of this specification can be implemented in, among other things, a method for providing geographic location information. The method includes a step for receiving a request for geographic location information from a mobile device, wherein requested geographic location information includes latitude and longitude coordinates for one or more data transmission points (DTPs), wherein a DTP includes wireless access points and cellular towers. The method also includes a step for determining a set of anticipated data transmission points (DTPs), wherein the anticipated DTPs are those DTPs that the mobile device is anticipated to require in the future. The method also includes a step for retrieving geographic location information associated with at least a portion of the anticipated DTPs from a locations catalog server. The method also includes a step for sending at least a portion of the retrieved geographic location information to the requesting mobile device.

This instant specification relates to location based services, particularly for determining the location of a mobile device.

### BACKGROUND

Mobile devices often provide location based services (LBSs), such as navigation or applications that try to make recommendations based upon where a user is expected to be at a certain time. A mobile device's location may be determined using GPS data, wireless access points (WAPs), or cellular towers or cellular antennae detected to be in range of a device. In some cases a device's location is determined by querying a location database to determine location information for the encountered wireless access points and or cellular towers, all of which are referred to as data transmission points (DTPs).

The problem is that a device may encounter new DTPs rapidly, and retrieving location information for the newly encountered DTPs from a locations catalog server may take considerable time, and may even fail, e.g., when a device is offline or out of range to communicate over the network. While attempted retrieval of location information is underway, the current location of a device may not be computed precisely, leading to a degradation of the quality of user experience with any particular LBS.

### SUMMARY

The subject matter relates to a method for providing geographic location information. The method includes a step for receiving a request for geographic location information from a mobile device, wherein requested geographic location information includes latitude and longitude coordinates for one or more data transmission points (DTPs), wherein a DTP includes wireless access points and cellular towers. The method also includes a step for determining a set of anticipated data transmission points (DTPs), wherein the anticipated DTPs are those DTPs that the mobile device is anticipated to require in the future. The method also includes a step for retrieving geographic location information associated with at least a portion of the anticipated DTPs from a locations catalog server. The method also includes a step for sending at least a portion of the retrieved geographic location information to the requesting mobile device. In some aspects, the anticipated set of DTPs may be determined based on a calculated current, habitual, or opportunistic path of a user of the mobile device. In some aspects, a current, habitual or opportunistic path may be determined based on historical DTPs encountered by the mobile device and received from the mobile device.

The disclosed subject matter further relates to a non-transitory computer-readable medium. The computer-readable medium includes instructions that, when executed by a computer, cause the computer to implement a method for providing geographic location information. The instructions include code for determining a set of anticipated data transmission points (DTPs) for a mobile device. The instructions also include code for retrieving geographic location information associated with at least a portion of the determined set of anticipated DTPs from a locations catalog server. The instructions also include code for sending at least a portion of the retrieved geographic location information to the mobile device.

The disclosed subject matter further relates to a system for providing geographic information location about one or more DTPs. The system includes a location information management module. The location information management module is configured to receive a request for location information from a mobile device. The location information management module is also configured to retrieve location information for a set of data transmission points (DTPs) from a locations catalog server. The location information management module is also configured to provide location information for the set of data transmission points (DTPs) to the mobile device. The system also includes an anticipate data points module. The anticipate data points module is configured to determine a set of anticipated DTPs that a user of the mobile device may encounter in the future. The anticipate data points module is also configured to provide the determined set of anticipated DTPs to the location information management module for retrieving location information.

The details of one or more implementations are set forth in the accompanying drawings and the description below. Other features and advantages will be apparent from the description and drawings, and from the claims.

### DESCRIPTION OF DRAWINGS

The features of the subject technology are set forth in the appended claims. However, for purpose of explanation, several aspects of the disclosed subject matter are set forth in the following figures.

FIG. 1 illustrates an example of a system configured for providing geographic location information.

FIG. 2 illustrates a system for providing geographic location information.

FIG. 3 illustrates a flowchart for providing geographic location information.

FIG. 4 illustrates a flowchart for providing geographic location information based on a computed path.

FIG. 5 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

A mobile device's location is typically determined, for example for providing location-based services (LBSs), by using either GPS data or wireless access points and/or cellular towers and their associated geographic location information. Wireless access points and/or cellular towers or cellular antennae are referred to in combination as data transmission points (DTPs) in this disclosure. Geographic location information of a DTP provides information about the known location of that data communication point, such as the latitude/longitude/elevation coordinates of the DTP, or the street address of the DTP, or the cross streets of where the DTP is located, or any other set of location information that would help in identifying the physical location of a particular data transmission point.

In some cases, a device gathers location information by monitoring radio spectra received from DTPs, which helps in identifying the DTPs in range of the device and retrieving location information for the encountered DTPs from a location catalog server. The retrieved location information is then used to determine the device's location (e.g., by using a technique known as triangulation). A problem with the described on-demand model for location determination is, when a device is moving, it may encounter new DTPs rapidly or may lose communication with the server, and retrieving location information for the newly encountered DTPs from the server may take considerable time, and may even fail, e.g., when a device is out of range or offline. While attempted retrieval of location information is underway, the current location of a device may not be computed precisely, leading to a degradation of the quality of user experience for LBSs.

The subject technology relates to systems and methods for managing location information on mobile devices, particularly for taking the on-demand model for providing location information and supplementing it with anticipated location data that a device may need in the future. Anticipated location information is supplied to a mobile device, for storing locally and in anticipation of it being needed as the device moves. One advantage of pre-fetching location data for anticipated DTPs is that a device in motion may be able to get location information locally, thereby not requiring costly communications with a backend locations catalog server for every newly encountered DTP. The aggregate advantage may be better user experience with LBSs provided by the mobile device and less power consumption.

In certain other aspects, a location information management system determines where a device is going, compute its predicted path, and pre-load geographic location information for a set of DTPs along the predicted path (e.g., the current path that the device is moving along). A predicted path may be determined using a recent history of a device's movement, speed, and the current location of the client device. In one aspect, the recent history used to compute a predicted path is the history of previously encountered DTPs by the device (e.g., DTPs encountered over the course of the last few seconds, minutes, and/or hours). Using the computed predicted path of a device, geographic location information for a set of DTPs along the computed predicted path is retrieved and sent to the mobile device in anticipation of it requiring that data in the future.

In various other aspects, pre-fetching of geographic location information is done by computing a habitual path (e.g., from home to work and vice-e-versa on weekdays) that a user is predicted to take and retrieving geographic location information for a set of DTPs along the computed habitual path, in anticipation of the user needing those points' location information if it moves along the computed habitual path. In one aspect, the habitual path is computed using the mobile device's longer term history of previously encountered DTPs (e.g., DTPs encountered over the course of the last so many days, weeks, months, and/or years).

In another aspect, a location information management system pre-fetches geographic location information for a set of DTPs along a computed opportunistic path. The computed opportunistic path (e.g., a device's user often detours to a coffee shop on the path from home to work) may be determined by using a search history of the user of the mobile device and the computed path along which it is currently moving or the computed habitual path that a user typically takes. Geographic location information for a set of DTPs along the computed opportunistic path is retrieved from a locations catalog database and sent to the mobile device.

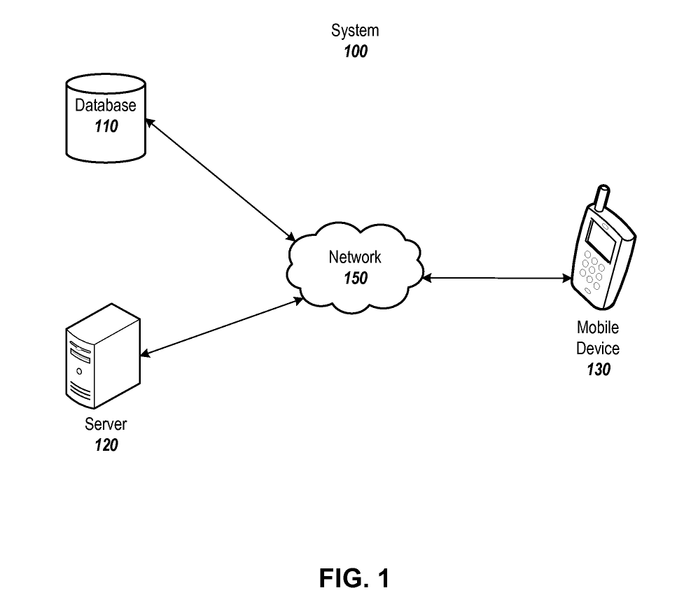

FIG. 1 illustrates an example of a system 100 configured to manage location information for a mobile device. As used herein, the phrase “geographic location” encompasses its plain and ordinary meaning including, but not limited to, a location within a physical space. A geographic location may be represented, for example, as a latitude, longitude, and/or elevation or as a street address. In some examples, a geographic location may be coupled with a radius of certainty (e.g., within two kilometers of a point or within 100 meters of a point). As shown, the system 100 includes a database 110, a server 120, a mobile device 130 and a computing device 140. The database 110, the server 120, the mobile device 130, and the computing device 140 may be configured to communicate with one another via a network 150. The network 150 may include the Internet, an intranet, a local area network, a wide area network, a wired network, a wireless network, a cellular network, a WiFi network, or a virtual private network (VPN).

The database 110 may store data (e.g., text, user data, location data, search history of a user of a mobile device, DTPs encounter by device by timestamp, physical location information for by DTP, etc.) related to a location management system. For example, database 110 may maintain a geographic location table with a column/attribute for a DTP identifier (e.g., a WAP id or a cellular tower identifier), one or more columns/attributes containing textual or other information about the geographic location of the particular DTP identified by the identifier of the row. The geographic location text may provide information such as the latitude/longitude/elevation coordinates of the DTP, street address of the DTP, and/or cross streets of where the DTP is located. The database may include a single machine, multiple machines, a single processor system, or a multi-processor system.

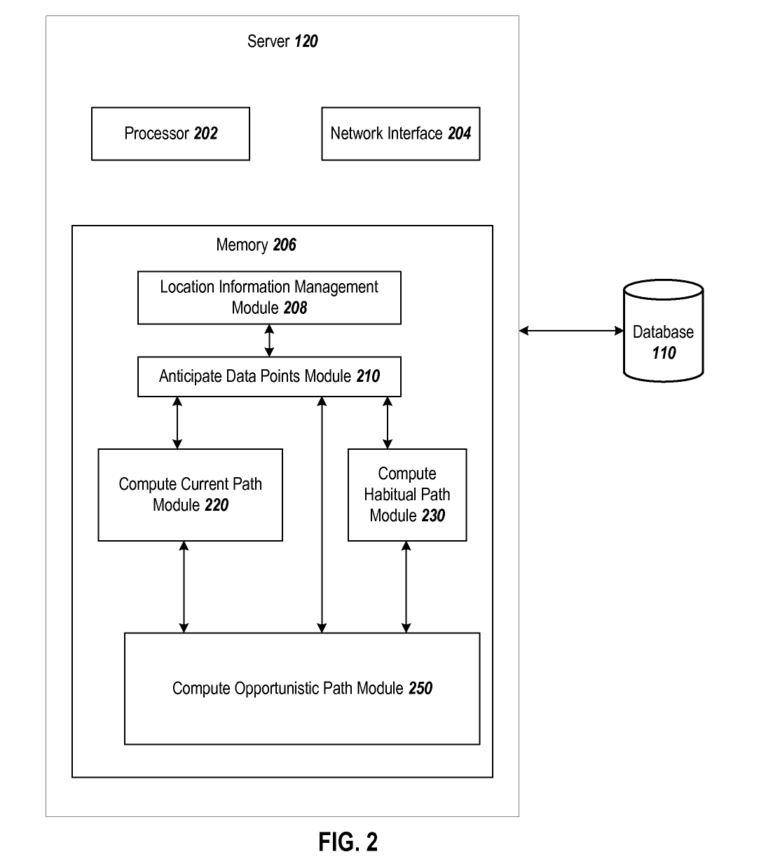

Database 110 may maintain another table for location history. A location history table may have one column for mobile device identifier, one column for timestamp, and one or more columns for storing DTPs received from the mobile device at the specified timestamp. The location history table may be used by path computation modules as described in more details for FIG. 2 below.

Database 110 may also maintain a search history table. The search history table may contain information about the search history of a user of the mobile device. Some example searches may be informational in nature (e.g., “who is the prime minister of England?”) or may be searches for a location (e.g., Chinese food in a region, a bank location, etc.) The search history table may have a column for mobile device identifier, one column for search identifier, one column for a search text, and other columns for maintaining links that a user visited from the search results of a search, etc. The search history table may be used by a computation module as described in more details for FIG. 2 below.

The server 120 may include programming modules for a location management system. The server 120 may be implemented as a single machine with a single processor, a multi-processor machine, or a server farm including multiple machines with multiple processors, or a cluster of virtual machines in the cloud. One example of the server 120 is described in more detail in conjunction with FIG. 2 below.

The mobile device 130 may be a mobile phone, a personal digital assistant (PDA), a tablet computer, a netbook, location device installed in an automobile, or a laptop computer. The mobile device 130 may be portable and may oftentimes be carried by a user, for example, in a pocket, a purse, a backpack, or a briefcase. The mobile device 130 may be configured to determine its geographic location, to communicate with server 120 to provide it with DTPs encountered as it moves, to communicate with server 120 to retrieve geographic location information for encountered and/or anticipated DTPs, and to locally store the retrieved geographic location information for those DTPs. A user of mobile device 130 may opt out or opt in from using the described configured services of mobile device 130. While only one mobile device 130 is illustrated in FIG. 1, the subject technology may be implemented in conjunction with one or more mobile devices 130.

While each of the database 110, the server 120, and the mobile device 130 are illustrated in FIG. 1 as separate machines, in example aspects, one or more of the database 110, the server 120, and the mobile device 130 may be implemented as a single machine. For example, the functions of the database 110 and the server 120 may be implemented within a single machine.

FIG. 2 illustrates an example of the server 120 in more detail, in communication with the database 110. As shown, the server 120 includes a processor 202, a network interface 204, and a memory 206. The processor 202 is configured to execute computer instructions that are stored in a computer-readable medium, for example, the memory 206. The processor 202 may be a central processing unit (CPU). While only one processor 202 is illustrated, the server 120 may include multiple processors. Furthermore, while the server 120 is illustrated as a single machine, the server 120 may include multiple machines, e.g., within a server farm or a set of virtual machines within a cloud. The network interface 204 is configured to allow the server 120 to transmit and receive data in a network, e.g., network 150 of FIG. 1. The network interface 204 may include one or more network interface cards (NICs). The memory 206 may store data or instructions. As illustrated, the memory 206 includes a location information management module 208, an anticipate data points module 210, a compute current path module 220, a compute habitual path module 230, and a compute opportunistic path module 250.

The location information management module 208 is configured to facilitate receiving, from a mobile device (e.g., mobile device 130), a request for geographic location information. The request for geographic location information may provide newly encountered DTPs with the request. The request may provide identifiers for the encountered DTPs, which may be stored on a database 210 by location information management module 208, e.g., in the location history table as described for database 110 of FIG. 1 above. The stored data may include the DTPs' identifiers, the mobile device id, a timestamp, and any other location information received from the mobile device or accessible by location information management module 208.

The location information management module 208 is also configured to communicate with the anticipate data points module 210 to receive a set of anticipated DTPs for the mobile device. Location information management module 208 can communicate with the database 110 to retrieve geographic location information for the provided DTPs' identifiers in the request, as well as for the anticipated DTPs received from the anticipate data points module 210. The geographic location information may be retrieved from a geographic location table as described for database 110 of FIG. 1 above, that maintains a mapping of DTPs' identifiers to their respective geographic location information. The retrieved location information may be communicated by the location information management module 208 to the mobile device.

The anticipate data points module 210 is configured to determine a set of anticipated DTPs along a current location, or computed path or paths that the device may take in the future. In one case, the anticipate data points module 210 may determine the current location of the mobile device (e.g., using provided encountered DTPs with a location information request) and select a set of anticipated DTPs nearby the current location to retrieve geographic location information for to provide to the requesting mobile device. For example, anticipate data points module 210 may select a set of points in certain geographic area surrounding (e.g., a square, circle, ellipse, etc.) the current location and use them as the anticipated DTPs to provide geographic location information for.

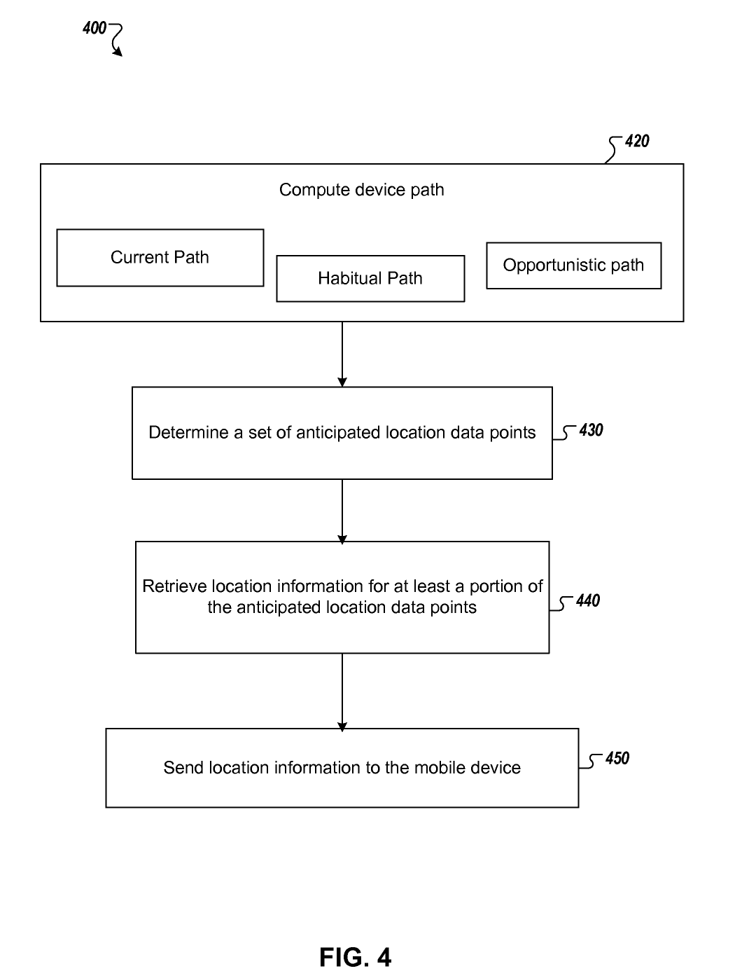

In other cases, the anticipate data points module 210 communicates with the compute current path module 220, the compute habitual path module 230, and the compute opportunistic path module 250, in order to receive computed paths along which to select a set of anticipated data points (discussed in more details for FIG. 4 below). After receiving one or more computed paths from the computation modules 220, 230 or 250, anticipate data points module 210 may select a set of DTPs along one or more of the computed paths and provide those DTPs to the location information management module 208. To select a set of anticipated DTPs along one or more of the computed paths, the anticipate data points module 210 may communicate with database 110 to determine which DTPs align the computed paths.

The compute current path module 220 is configured to compute the current path of the mobile device. The compute current path module 220 is also configured to communicate with database 110 to retrieve a recent history of the movement of the mobile device (e.g., previously encountered DTPs by the mobile device over the course of the last few seconds, minutes, or hours), to use for computing the current path of the mobile device. The recent history may be received from the location history table as described for database 110 of FIG. 1.

A recent history of locations for the mobile device may for example involve analyzing received DTPs over the last five minutes or half an hour. The current path may be computed by computing the start point of the device, using the provided DTP identifiers from the mobile device, by computing the direction that the mobile device is moving in, using the recent history for location of the mobile device (e.g., previously encountered DTPs by the mobile device over the course of previous days, weeks, months, or years as stored in the location history table described for database 110 of FIG. 1), and by calculating the speed of the mobile device. The computed current path may be provided to the anticipate data points module 210 by the compute current path module 220.

The compute habitual path module 230 is configured to compute the habitual path of the mobile device. An habitual path is a path that a user of the mobile device has been observed to take repeatedly over a certain period of time. For example, by using a longer location history of the mobile device (e.g., from the location history table of the mobile device), a habitual path may be computed for a user that goes to work every weekday from home to her work address, using a particular route. The habitual path may be computed by studying a longer history of location data for the mobile device than the recent location history as described for calculating the current path of the mobile device. For example, a habitual path may be determined by analyzing location history of a mobile device over months or years. The computed habitual path may then be provided to the anticipate data points module 210 by the compute habitual path module 230.

The compute opportunistic path module 250 is configured to compute one or more opportunistic paths that a user of the mobile device may want to take. An opportunistic path is a path that a user may want to take along its computed current path or computed habitual path. For example, by using a search history of a user of the mobile device (e.g., from the search history table of the mobile device), compute opportunistic module 250 may determine that the user of the mobile device likes to go to a coffee shop on her way to work from home. In some implementations, the type of searches from a search history that may be used for computing an opportunistic path may be a location type of search (e.g., Chinese food search, a bank location search, etc.) In some implementations, if the current path or the habitual path is determined to be the path from work to home, the compute opportunistic path module 250 may compute paths, e.g., to coffee shops or other locations determined to be of interest to the user by analyzing the user's search history, near the current or habitual path that the user of the mobile device is travelling on.

Compute opportunistic path module 250 is configured to communicate with the compute current path module 220 to get the current path that a user is travelling on, and to communicate with the compute habitual path module 230 to get the habitual path that a user habitually takes. The computed opportunistic paths may be provided to the anticipate data points module 210 by the compute opportunistic path module 250. Alternatively, the compute opportunistic path module 250 may provide computed opportunistic paths to the compute current path module 220 or the compute habitual path module 230, to use for supplying computed opportunistic paths along with the computed current path or computed habitual path respectively to the anticipate data points module 210.

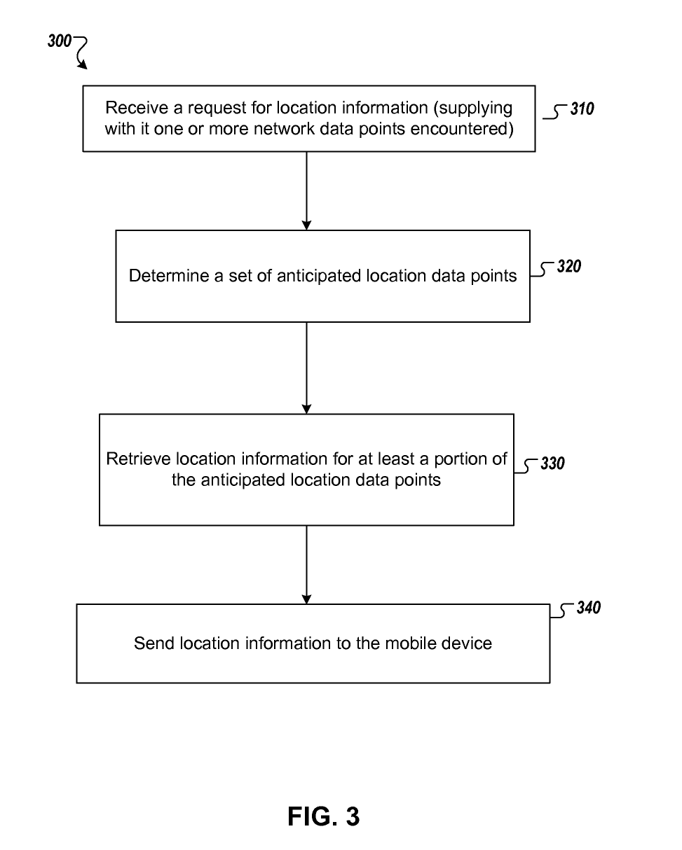

FIG. 3 illustrates a flowchart for providing geographic location information. Process 300 of FIG. 3 provides current geographic data and anticipated geographic data based on either the current location and a set of anticipated data points near the current location, and/or based on one or more calculated or anticipated paths. At step 310, a request for location information is received, for example by the location information management module 208 of FIG. 2. The request for location information at step 310 may or may not include with it one or more network data points or newly encountered DTPs. The request for location information at step 310 may be initiated either by a mobile device (e.g., that requires geographic information for a set of newly encountered DTPs or otherwise) or it may be initiated by a server module periodically (e.g., by the location management module 208 of FIG. 2).

In one aspect, the request received at step 310 is triggered when one ore more newly encountered DTPs are detected by a mobile device. Such an event can cause the mobile device to request for location information for the newly detected network data points, thereby providing an opportunity to piggyback pre-fetching of anticipated data points' location information with the received request for newly encountered network data points' location information.

In another aspect, step 310's request for location information is triggered by a device encountering a certain number of un-anticipated DTPs (those DTPs for which there is no local location information available, e.g., in a local database of the mobile device). In one implementation, the number of un-anticipated DTPs that trigger a step 310 request is based on a calculated satisfaction rate, perhaps ranging from 0% to 100%. For example, if the local database or cache hit ratio for encountered DTPs is 100% then do not recalculate. However, if the local database or cache hit ratio falls below a certain percent then recalculate or invoke a step 310 request for location information. In another implementation, a recalculation of anticipated DTPs is triggered based on a certain amount of elapsed time in which the mobile device does not come across an access point that is available in the local cache or database. The elapsed time for encountering DTPs may be set for a longer interval in a rural setting than in an urban setting.

In yet another aspect, the reevaluation of DTPs to pre-fetch may be based on keeping track of two geometric shapes (e.g., rectangular area, circular area, elliptical area, etc.) along a user's path, one geometric shape being a smaller area, and located inside of a larger geometric shape. In such a case, as long as the user's movement remains within the smaller shape, no recalculation is performed. However, as a user's movement is determined to be some where between the boundaries of the smaller and the larger shape, then a recalculation may be triggered, by for example invoking step 310 request for location information. In some aspects, the shapes may comprise of two zigzag shapes, running in parallel overlaying the user's path, one zigzag being the inner zigzag shape and the other being the larger/outer zigzag shape. As a user's movement, is determined to go outside of the inner zigzag, into the outer zigzag area, a recalculation may be triggered. In some implementations, one geometric shape may be maintained and as the user's movement is determined to go outside of the one shape, a recalculation of DTPs to pre-fetch may be triggered.

The triggering event at step 310 may be client triggered (as discussed above) or may be server initiated. For example, a recalculation or request for location information may be triggered by a location management system itself, periodically re-evaluating a path and associated DTPs, to preemptively supply location information to a mobile device in anticipation of it needing it in the near future.

In either case, whether client or server initiated, a request for location information at step 310 leads to determining a set of anticipated data points at step 320. The location information management module 208 of FIG. 2 may communicate with anticipate data points module 210 to receive anticipated data points. The anticipated data points may be determined using various aspects discussed below, including computed paths as discussed in more details for FIG. 4 below.

In one aspect, a module of a central server (e.g., anticipate data points module 210 of FIG. 2) determines a set of access points near the current location of the device (those DTPs that are nearby but not yet visible or in range of the client device) and sends location information for them to handle un-anticipated types of scenarios. Nearby DTPs may be determined by taking a certain set of DTPs in a predefined, user or system configurable, area surrounding the current location of the requesting mobile device. The current location may be determined using the one or more network data points where provided in the request at step 310. In other cases, where step 310 did not include one or more encountered data points (e.g., in a server initiated geographic location information request), anticipate data points module 210 may use a user's recent history to calculate or determine the current location.

One skilled in the art can appreciate a host of other algorithms or heuristics applied to determine nearby DTPs without deviating from the scope of this disclosure. Calculated nearby DTPs may be supplied in addition to pre-fetching of data along a user's current, predicted, habitual, or opportunistic paths (as discussed in more details for FIG. 4 below). More location data may be pre-loaded for DTPs along the current, predicted or habitual path than for points nearby the predicted or habitual path (as discussed in more details for FIG. 4 below).

At step 330, location information is retrieved for at least a portion of the anticipated location data points, determined at step 320. For example, a locations catalog server (e.g., implemented on database 110) may be queried, by for example the location information management module 208, to get location information for one or more anticipated data transmission or network points. Location information about the one or more anticipated location data points may include for example longitude, latitude, or elevation information or the street address for the anticipated data point. Location information may comprise of any other set of information for the location data point that may help in determining the physical or geographic location of the location data point.

The amount of location data to pre-fetch may be user or system configurable. The amount of data to pre-fetch may also depend on current information about a user or device, a particular device's capacity, current bandwidth and response times, recent or historical user activity, etc. The area for which to pre-load location data points may depend on the type of environment a user is travelling in, e.g., rural versus urban settings. This could be because urban settings generally have more DTPs in a given area than a rural setting, so the system may supply data sets for a bigger range for rural setting as compared to urban settings. As such, step 320 for determining a set of anticipated data points and/or step 330 that retrieves location information for at least a portion of the anticipated data points may limit its respective query based on the desired amount of location data to supply for the request for location information.

At step 340, location information retrieved for the one or more anticipated data points is sent to the mobile device that requested location information at step 310. In another case, where request at step 310 is server-initiated, location information retrieved for the one or more anticipated data points at step 340 is sent to a mobile device for which the server initiated the recalculation. The location information supplied at step 340 may include location information for anticipated location data points, along with location information for the one or more network data points, if supplied with the request at step 310. The central server may also supply updates to location information for previously supplied DTPs, along with information being sent for new and/or anticipated DTPs at step 340.

Location information provided at step 340 may help provide a better user experience or better power consumption by delivering anticipated location information to the device prior to the device encountering those location or transmission data points.

FIG. 4 illustrates a flowchart for providing geographic location information based on a computed path. Step 420 of process 400 may be triggered by a request for location information as discussed for step 310 in process 300 of FIG. 3. At step 420 device path is computed, for example either the current or predicted path, habitual, or opportunistic path, e.g., by the compute current path module 220, or compute habitual path module 230, or compute opportunistic path module 250 respectively.

In one aspect, compute current path module 220 determines where a mobile device is going to compute its predicted path. A predicted or current path may be computed using a recent history (e.g., over the past few seconds or minutes) of a device's movement, speed, and the current location, using a set of previously received DTPs for the mobile device.

In another aspect, a habitual path that a user is predicted to take is computed. A habitual path may be computed using a longer history of device movement (e.g., over weeks, months, or years). For example, an analysis of a device's longer history of movement may reveal a user takes a particular path to work and back every day of the week, then where the system determines the current day of the week to be a week day, it may provide a set of DTPs along the work path in anticipation of the user driving to work on the computed habitual path.

In addition to sending location information for DTPs for a user's habitual path, information about extensions to a user's habitual path may also be supplied. For example, if a user detours typically to go to a restaurant or gas station every week, then location information for restaurants and gas stations near the habitual or predicted paths may also be pre-fetched. Furthermore, more generally location information for services (e.g., coffee shops, grocery stores, dry cleaners, restaurants, etc., especially when available at a discounted rate) that are about to come up along the user's current, predicted, or habitual path may also be supplied.

In yet another aspect, an opportunistic path is computed. The computed opportunistic path may be determined by using a search history of the user of the mobile device and the computed path along which it is currently moving or a computed habitual path. For example, an analysis of a user's search history may reveal a common search for coffee shops when travelling on a path from work to home. If the analysis of the current path or compute habitual path results in the work to home path, then based on the past user history of searching for coffee shops, a set of DTPs along (the opportunistic) paths to nearby coffee shops may be pre-loaded.

At step 430 a set of anticipated data points are determined along the computed paths (e.g., current, habitual or extensions of habitual, or opportunistic paths). The set of anticipated DTPs may be taken as a subset of the DTPs along a computed path. Step 430 may also take a certain set of nearby DTPs, near the calculated path, to provide with DTPs along the calculated path(s). The nearby DTPs maybe determined by taking an area (e.g., circular, elliptical, or rectangular, etc.) overlaying the calculated predicted path, habitual path, or opportunistic paths.

At step 440, location information is retrieved for at leas a portion of the anticipated location data points for step 430. The location information may be retrieved from a database 110 maintaining a geographic location information table as described for FIG. 1. At step 450, location information retrieved for a set of anticipated data points is sent to the mobile device for which the computation was done (e.g., the requesting mobile device in the case of a client-initiated request for geographic location data or the mobile device on whose behalf the calculation is initiated in the case of a server-initiated calculation).

Processes 300 and 400 of FIGS. 3 and 4 are example processes for pre-fetching location information to improve the quality of location based services. One skilled in the art can appreciate a host of variations in the steps illustrated in processes 300 and 400 without deviating from the scope of this disclosure. The steps of processes 300 and 400 may either be performed sequentially or simultaneously or partially sequentially and partially simultaneously without deviating from the scope of this disclosure. The steps may be performed in the order illustrated or in any other order or combination.

In another aspect, it is possible to download all of the information about DTPs and cell towers on a regional basis (neighborhood, metropolitan region, or state/province). However, in such an implementation much of that data will never be used, and in fact may change before it is eventually used. A more careful method which relies upon the short-term expected position of the device will consume less battery power on the device and will require less storage space on the device (as described for FIGS. 3 and 4 above).

Aspects of the subject technology involve receiving and storing of location information for a mobile device. The receiving and storing of location information is known to the user of the mobile device and described in contextual notices provided to the user in plain language, for example, when the user downloads or executes an application. Furthermore, persistent reminders are provided in the user interface of the mobile device that location information is being transmitted and stored. In some aspects, periodic reminders are provided to the user when the user logs into an application (e.g., every tenth login or every thirty days) or electronic messages (e.g., email) are provided to the user to remind him/her of the transmission and storage of location information.

The user explicitly and affirmatively provides consent to allowing the transmission and storing of location information, and may easily withdraw or revoke such consent at any time via the user interface of the mobile device. Furthermore, the user may remove any location information associated with the mobile device of the user stored by the service (e.g., in a data repository or a server). In some aspects, a privacy dashboard is provided via the mobile device that allows the user to determine which information about his/her current or past geographic locations is stored by the service or by the mobile device or to remove such information from the service or from the mobile device. Furthermore, all geographic location information is encrypted when transmitted over a network to prevent unauthorized access to the geographic location information.

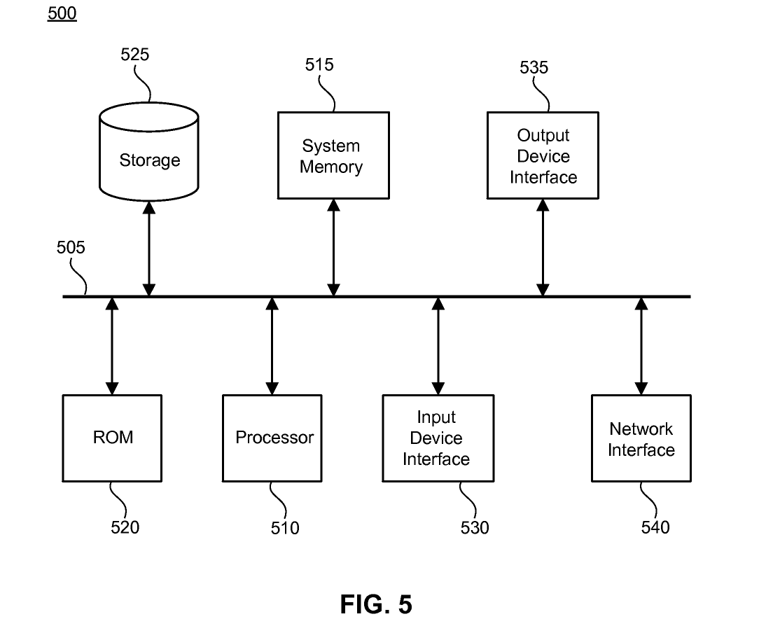

FIG. 5 conceptually illustrates an electronic system 500 with which some implementations of the subject technology are implemented. For example, one or more of the database 110, the server 120, or the mobile device 130 may be implemented using the arrangement of the electronic system 500. The electronic system 500 can be a computer (e.g., a mobile phone, PDA), or any other sort of electronic device. Such an electronic system includes various types of computer readable media and interfaces for various other types of computer readable media. Electronic system 500 includes a bus 505, processing unit(s) 510, a system memory 515, a read-only memory 520, a permanent storage device 525, an input device interface 530, an output device interface 535, and a network interface 540.

The bus 505 collectively represents all system, peripheral, and chipset buses that communicatively connect the numerous internal devices of the electronic system 500. For instance, the bus 505 communicatively connects the processing unit(s) 510 with the read-only memory 520, the system memory 515, and the permanent storage device 525.

From these various memory units, the processing unit(s) 510 retrieves instructions to execute and data to process in order to execute the processes of the subject technology. The processing unit(s) can be a single processor or a multi-core processor in different implementations.

The read-only-memory (ROM) 520 stores static data and instructions that are needed by the processing unit(s) 510 and other modules of the electronic system. The permanent storage device 525, on the other hand, is a read-and-write memory device. This device is a non-volatile memory unit that stores instructions and data even when the electronic system 500 is off. Some implementations of the subject technology use a mass-storage device (for example a magnetic or optical disk and its corresponding disk drive or a semiconductor/flash memory) as the permanent storage device 525.

Other implementations use a removable storage device (for example a floppy disk, flash drive, and its corresponding disk drive) as the permanent storage device 525. Like the permanent storage device 525, the system memory 515 is a read-and-write memory device. However, unlike storage device 525, the system memory 515 is a volatile read-and-write memory, such a random access memory. The system memory 515 stores some of the instructions and data that the processor needs at runtime. In some implementations, the processes of the subject technology are stored in the system memory 515, the permanent storage device 525, or the read-only memory 520. For example, the various memory units include instructions for improving location quality by pre-fetching AP or DTPs location information in accordance with some implementations. From these various memory units, the processing unit(s) 510 retrieves instructions to execute and data to process in order to execute the processes of some implementations.

The bus 505 also connects to the input and output device interfaces 530 and 535. The input device interface 530 enables the user to communicate information and select commands to the electronic system. Input devices used with input device interface 530 include, for example, alphanumeric keyboards and pointing devices (also called “cursor control devices”). Output device interfaces 535 enables, for example, the display of images generated by the electronic system 500. Output devices used with output device interface 535 include, for example, printers and display devices, for example cathode ray tubes (CRT) or liquid crystal displays (LCD). Some implementations include devices for example a touchscreen that functions as both input and output devices.

Finally, as shown in FIG. 5, bus 505 also couples electronic system 500 to a network (not shown) through a network interface 540. In this manner, the electronic system 500 can be a part of a network of computers (for example a local area network (“LAN”), a wide area network (“WAN”), or an Intranet, or a network of networks, for example the Internet. Any or all components of electronic system 500 can be used in conjunction with the subject technology.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

1. A computer-Implemented method for providing geographic location information, the method comprising:
receiving, by one or more computing devices, a request for geographic location information from a mobile device, wherein requested geographic location information includes latitude and longitude coordinates for one or more data transmission points (DTPs), wherein a DTP includes wireless access points and cellular towers;
determining, by the one or more computing devices, a predicted path of the mobile device based at least in part on a history of DTPs previously encountered by the mobile device;
determining, by the one or more computing devices, a set of anticipated data transmission points (DTPs) based at least in part on the predicted path, wherein the anticipated DTPs include both the DTPs that the mobile device is anticipated to encounter in the future along the predicted path and at least one additional DTP contained within a specified area surrounding at least a portion of the predicted path, the at least one additional DTP corresponding to one or more DTPs that the mobile device will potentially encounter in the future if the mobile device travels off of the predicted path within the specified area:
retrieving, by the one or more computing devices, geographic location information associated with at least a portion of the anticipated DTPs from a locations catalog server; and
sending, by the one or more computing devices, at least a portion of the retrieved geographic location information to the requesting mobile device.

2. The computer-implemented method of claim 1, wherein the request for geographic location information is received from the mobile device when the mobile device encounters a certain number of DTPs for which it has no locally stored geographic location information.

3. The computer-implemented method of claim 1, wherein determining the predicted path of the mobile device comprises:
computing, by the one or more computing devices, a current path of the mobile device based at least in part on a current location of the mobile device and the history of DTPs previously encountered by the mobile device, wherein the computation of the current path is performed by predicting a direction along which the mobile device will move from the current location based on the history of the DTPs previously encountered by the mobile device, wherein the anticipated DTPs are determined based at least in part on the computed current path.

4. The computer-implemented method of claim 3, further comprising:
computing, by the one or more computing devices, an opportunistic path for the mobile device based at least in part on the computed current path and a search history of a user of the mobile device, wherein the anticipated DTPs are determined based at least in part on the computed opportunistic path.

5. The computer-implemented method of claim 1, wherein determining the predicted path of the mobile device comprises:
computing, by the one or more computing devices, a habitual path of the mobile device based at least in part on the history of DTPs previously encountered by the mobile device, the habitual path corresponding to a path that has been previously traversed by the mobile device two or more times, wherein the anticipated DTPs are determined based at least in part on the computed habitual path.

6. The computer-implemented method of claim 5, further comprising:
computing, by the one or more computing devices, an opportunistic path based on the computed habitual path and a search history of a user of the mobile device, wherein the anticipated DTPs are determined based at least in part on the computed opportunistic path.

7. (canceled)

8. The computer-implemented method of claim 1, wherein the at least one additional DTP chosen from the specified area surrounding the at least a portion of the predicted path of the mobile device corresponds to a larger set of DTPs when the mobile device is in a urban setting than when the mobile device is in a rural setting.

9. A non-transitory computer-readable medium storing instructions that when executed cause one or more computing devices to perform operations for pre-fetching location information, the operations comprising:
determining a predicted path of a mobile device based at least in part on a history of data transmission points (DTPs) previously encountered by the mobile device;
determining a set of anticipated data transmission points (DTPs) for the mobile device based at least in part on the predicted path, wherein the anticipated DTPs include both the DTPs that the mobile device is anticipated to encounter in the future along the predicted path and at least one additional DTP contained within a specified area surrounding at least a portion of the predicted path, the at least one additional DTP corresponding to one or more DTPs that the mobile device will potentially encounter in the future if the mobile device travels off of the predicted path within the specified area;
retrieving geographic location information associated with at least a portion of the determined set of anticipated DTPs from a locations catalog server; and
sending at least a portion of the retrieved geographic location information to the mobile device.

10. (canceled)

11. The computer-readable medium of claim 9, wherein the determining of the predicted path of the mobile device is initiated by the mobile device or a server process.

12. The computer-readable medium of claim 9, wherein determining the predicted path of the mobile device comprises calculating a current path of the mobile device based at least in part on a current location of the mobile device and the history of DTPs previously encountered by the mobile device, wherein the calculation of the current path is performed by predicting a direction along which the mobile device will move from the current location based on the history of the DTPs previously encountered by the mobile device.

13. The computer-readable medium of claim 9, wherein determining the predicted path of the mobile device comprises calculating a habitual path of the mobile device based at least in part on the history of DTPs previously encountered by the mobile device, the habitual path corresponding to a path that has been previously traversed by the mobile device two or more times.

14. The computer-readable medium of claim 9, wherein determining the predicted path of the mobile device comprises calculating an opportunistic path based at least in part on the history of DTPs previously encountered by the mobile device and a search history of a user of the mobile device.

15. The computer-readable medium of claim 9, wherein the at least one additional DTP chosen from the specified area surrounding the at least a portion of the predicted path of the mobile device corresponds to a larger set of DTPs when the mobile device is in a urban setting than when the mobile device is in a rural setting.

16. A computing device comprising:
at least one processor and associated memory, the memory storing instructions that, when implemented by the at least one processor, configure the computing device to:
predict at least one of a habitual path or a current path of a mobile device based at least in part on a history of data transmission points (DTPs) previously encountered by the mobile device;
determine an opportunistic path based on the at least one of the habitual path or the current path of the mobile device and a search history of a user of the mobile device, the opportunistic path corresponding to a travel path connected to the at least one of the habitual path or the current path that leads to a predicted location of interest for the mobile device based on the search history;
determine a set of anticipated DTPs for the mobile device based at least in part on the opportunistic path and the at least one of the habitual path or the current path, the anticipated DTPs corresponding to DTPs that the mobile device is anticipated to encounter in the future along the opportunistic path and the at least one of the habitual path or the current path;
retrieve location information for at least a portion of the set of anticipated DTPs from a locations catalog server; and
provide at least a portion of the retrieved location information to the mobile device.

17. The computing device of claim 16, wherein the computing device configured to:
predict the current path of the mobile device based at least in part on a current location of the mobile device and the history of DTPs previously encountered by the mobile device, wherein the prediction of the current path is performed by predicting a direction along which the mobile device will move from the current location based on the history of the DTPs previously encountered by the mobile device.

18. The computing device of claim 16, wherein the computing device is configured to:
predict the habitual path of the mobile device based at least in part on the history of DTPs previously encountered by the mobile device, the habitual path corresponding to a path that has been previously traversed by the mobile device two or more times.

19. (canceled)

20. (canceled)

21. The computer-implemented method of claim 4, wherein the opportunistic path corresponds to a travel path connected to the current path that leads to a predicted location of interest for the mobile device based on the search history.

22. The computer-implemented method of claim 6, wherein the opportunistic path corresponds to a travel path connected to the habitual path that leads to a predicted location of interest for the mobile device based on the search history.

23. The computing device of claim 16, wherein the anticipated DTPs further include at least one additional DTP contained within a specified area surrounding at least a portion of at least one of the opportunistic path or the at least one of the habitual path of the current path, the at least one additional DTP corresponding to one or more DTPs that the mobile device will potentially encounter in the future if the mobile device travels off of the at least one of the opportunistic path or the at least one of the habitual path of the current path within the specified area.

24. The computing device of claim 23, wherein the at least one additional DTP chosen from the specified area surrounding the at least a portion of the predicted path of the mobile device is corresponds to a larger set of DTPs when the mobile device is in a urban setting than when the mobile device is in a rural setting.
